(19) United States
(12) Patent Application Publication
(10) Pub. No.: US 2009/0039561 A1
(43) Pub. Date: Feb. 12, 2009

(54) Production method of tone wheel

(75) Inventor: Yoshihiko Yamaguchi, Okayama (JP)

Correspondence Address: BACON & THOMAS, PLLC, 625 SLATERS LANE, FOURTH FLOOR, ALEXANDRIA, VA, 22314-1176, US

(73) Assignee: Uchiyama Manufacturing Corp., Okayama (JP)

(21) Appl. No.: 12/219,351

(22) Filed: Jul. 21, 2008

(30) Foreign Application Priority Data
Jul. 20, 2007 (JP) 2007-189842

(51) Int. Cl. B29C 69/00

(52) U.S. Cl. 264/429

(57) ABSTRACT

A newly developed method for manufacturing a tone wheel is disclosed, according to which a circular magnetic molded body made from a magnetic powder is enable to be combined with a metal reinforcing ring without deformation and partial breakage in the assembly process.

The method is characterized by manufacturing a tone wheel with an elastic member disposed between the metal reinforcing ring and the circular magnetic body and comprises providing step of a circular magnetic body formed with an elastic member disposing portion on a circumferential surface of the metal reinforcing ring on a magnetic sensor side, fixing step of an elastic member into the elastic member disposing portion to make a composite member body, and bending step of the circumferential edge of the metal reinforcing ring to fix the composite member body thereby.

### TECHNICAL FIELD

The present invention relates to a production method of a tone wheel constituting a magnetic encoder for detecting the rotation number of the wheel of automobile and more particularly relates to a tone wheel provided to detect the rotation number of the wheel to be applied to an antilock brake system or a traction control system of automobiles.

### BACKGROUND ART

The wheel of automobile is sometimes equipped with a magnetic encoder for detecting the rotation number. Such a magnetic encoder may be comprised of a tone wheel constituted with a rotating member of the wheel like a wheel bearing system together with a slinger (metal reinforcing ring) of a seal ring and a magnetic sensor which is fixed on the automobile body (stationary member side) and is provided so as to closely confront the surface of the tone wheel. On the other hand, a tone wheel may be employed such that it is fitted in and fixed to the rotary side member via a metal reinforcing ring other than the seal ring and is provided so as to confront the magnetic sensor of the automobile body. Such a tone wheel is comprised of a metal reinforcing ring which is mounted to the rotary side member to be integrally fitted and a circular magnetic body fixed to the metal reinforcing ring. The circular magnetic body may be a circular rubber magnet or a circular plastic magnet which is constructed such that a circular magnetic rubber sheet or a resin molded body containing a magnetic powder is magnetized with S poles and N poles formed alternately along the circumferential direction.

When the tone wheel is used for detecting the rotation of automobile wheel, it is apt to be used in a hard circumstances where foreign materials such as water, dirt, and dust scatter. In order to stably executing the rotation detection for a long time, it is required that the circular magnetic body is not peeled off and is firmly fixed and integrated with the metal reinforcing ring.

The following patent documents 1-3 disclose an example in which the edge of metal reinforcing ring is caulked into the circular magnetic body side and the circular magnetic body is fixed and integrated with the circular magnetic body.

[Patent document 1] JP-2004-84925-A
[Patent document 2] JP-9-133698-A
[Patent document 3] JP-2005-274436-A

### DISCLOSURE OF INVENTION

### Problems to be Solved in the Invention

The patent document 1 discloses a magnetic encoder in which a multipolar magnet (circular magnetic body) is fixed to a core metal (metal reinforcing ring) by caulking. The patent document 2 discloses a bearing unit in which a core material has a circular ring section and a holding cylinder part which is bent inwardly from the external peripheral edge of the circular ring section, the holding cylinder part is formed with a caulking portion projecting inwardly in a diametrical direction, the diameter of the largest inscribed circle of the caulking portion is made smaller than the external diameter of the multipolar magnet and the peripheral edge of the multipolar magnet and the caulking portion are restrained. The patent document 3 discloses an encoder in which a permanent magnet (circular magnetic body) is held between a plurality of locking claws of a slinger and a flange section.

However, according to such a production method of tone wheel in which the edge of the metal reinforcing ring is directly fixed by caulking to the edge of the circular magnetic body, the caulking process is very difficult and many problems are pointed out. For example, if a rubber magnet is used as a circular magnetic body, it is elastically deformed by the caulking strength and a magnetic face is not formed uniformly. Or when a plastic magnet is used as a circular magnetic body, it is apt to be cracked and broken when a metal reinforcing ring made of stainless steel is caulked because the plastic magnet is relatively hard.

When a broken circular magnetic body is used as a tone wheel, even if it is broken slightly, water may enter from the gap and the circular magnetic body may be further broken when the entered water gets frozen. In addition, if the magnetic surface is not uniform or the deformation and damage of the circular magnetic body are proceeded, there causes a problem of the measurement accuracy of rotation detection. Further, for producing a tone wheel, the productivity is reduced when a caulking process has difficulty, therefore an improvement is desired.

The present invention is proposed in view of the above-mentioned problems and its object is to provide a production method of a tone wheel in which a circular magnetic body can be fixed and integrated to a metal reinforcing ring without being deformed or broken.

### Means to Solve the Problems

The first aspect of the present invention is characterized by a production method of a tone wheel, constituting a rotation detection magnetic encoder in combination with a magnetic sensor fixed onto a stationary side member, comprising a metal reinforcing ring fitted into a rotary side member and a circular magnetic body molded from a magnetic powder fixed to the metal reinforcing, wherein the method comprises providing the circular magnetic body being formed with an elastic member disposing portion on its circumferential surface, fixing an elastic member to the elastic member disposing portion to make a composite member body, the elastic member having a corresponding shape to be incorporated into the elastic member disposing portion, and bending the circumferential edge of the metal reinforcing ring to fix the composite member body to the reinforcing ring, thereby producing a tone wheel with the elastic member disposed between the metal reinforcing ring and the circular magnetic body.

The second aspect of the present invention is characterized in that in the production method of a tone wheel as set forth in the first aspect, the composite member body is made by placing the circular magnetic body formed with the elastic member disposing portion in a cavity of a forming die and then charging an unvulcanized elastic member in the cavity for a molding.

Molding method includes an injection molding, a compression molding and the like.

According to the third aspect of the present invention, in the production method of a tone wheel as set forth in the first aspect, the elastic member is an O-ring.

The fourth aspect of the production method of a tone wheel, constituting a rotation detection magnetic encoder in combination with a magnetic sensor fixed onto a stationary side member, comprising a metal reinforcing ring fitted into a rotary side member and a circular magnetic body fixed to the metal reinforcing ring, the circular magnetic body being molded from a magnetic powder is characterized in that the method comprises attaching an elastic member to a surface of the metal reinforcing ring facing to the magnetic sensor, disposing the circular magnetic body on the surface of the metal reinforcing ring facing to the magnetic sensor and bending the circumferential edge of the reinforcing ring to fix the circular magnetic body to the reinforcing ring, thereby producing a tone wheel with the elastic member disposed between the metal reinforcing ring and the circular magnetic body.

According to the fifth aspect of the present invention, in the production method of a tone wheel as set forth in the first and the fourth aspects, the metal reinforce ring has a cylindrical portion to be fitted into the rotary side member and an outward brim portion extendedly formed at an edge of the cylindrical portion, the outward brim portion faces to the magnetic sensor, and the elastic member is disposed all around circumferential end of the circular magnetic body.

According to the sixth aspect of the present invention, in the production method of a tone wheel as set forth in the fifth aspect, a projecting portion is further provided at one end or at both ends of the elastic member.

According to the seventh aspect of the present invention, in the production method of a tone wheel as set forth in any one of the fourth to sixth aspects, the elastic member disposing portion is made as a portion formed with a step on which the elastic member is incorporated.

According to the eighth aspect of the present invention, in the production method of a tone wheel as set forth in any one of the first to seventh aspects, the metal reinforcing ring is formed with a bent portion with a sharp angle, by which the composite member body or the circumferential end of circular magnetic body is fixed to the metal reinforcing ring.

According to the ninth aspect of the present invention, in the production method of a tone wheel as set forth in any one of the first to eighth aspects, the bent portion is provided all around the edge of the metal reinforcing ring or a plurality of the bent portions are partially provided at the circumferential edge of the metal reinforcing ring.

According to the tenth aspect of the present invention, in the production method of a tone wheel as set forth in any one of the first, second and fourth to ninth aspects, the elastic member is partially incorporated into the circumferential edge of the circular magnetic body.

### EFFECT OF THE INVENTION

According to the production method of a tone wheel of the present invention, the tone wheel in which the circular magnetic body is firmly fixed and integrated to the metal reinforcing ring by bending the edge of the metal reinforcing ring can be produced. The elastic member held between the metal reinforcing ring and the circular magnetic body is served as an appropriate buffer material at the time of bending process and the bending force at the bent portion is absorbed by the elastic member to prevent the bending force from directly applying to the circular magnetic body. Therefore, there is little fear of causing breakage or deformation on the circular magnetic body at a production stage, thereby facilitating the bending process and enabling to produce the tone wheel at high productivity.

Further, according to thus produced tone wheel, the elastic member is held between the bent portion of the metal reinforcing ring and the circular magnetic body, so that the tone wheel does not require a sealing agent, water is prevented from entering between the metal reinforcing ring and the circular magnetic body from the gap between the bent portion and the circular magnetic body and the deterioration of the circular magnetic body is prevented even when the tone wheel is used in such a severe conditions like the detection portion for an automobile wheel rotation when foreign materials such as water, dirt and dust scatter.

The circular magnetic body does not drop off the metal reinforcing ring without depending on an adhesive by the effect of the elastic member as a buffer material, the effect of the elastic member as the sealing material and the restraint force of the bent portion, thereby obtaining the tone wheel which has a long durability and contributing to a highly accurate rotation detection. In addition the tone wheel produced by this method does not have a fear of breaking or deforming the circular magnetic body, so that an adverse effect on the detection accuracy of rotation by the bending process is not required to be concerned.

According to the production method of a tone wheel of the first aspect of the present invention, the circular magnetic body and the elastic member are separately molded and the composite member is constructed by combining them, so that if each member is made of different material, an integrated member as the composite member can be assembled into the metal reinforcing ring, thereby facilitating a production method.

According to the production method of a tone wheel of the second aspect of the present invention, the elastic member is integrally molded with the circular magnetic body at a molding process, so that the circular magnetic body and the elastic member are firmly integrated and a combining process of the circular magnetic body and the elastic member is not required, thereby simplifying a production process of the tone wheel and facilitating the production.

According to the production method of tone wheel of the third aspect of the present invention, a commercially available O-ring can be used. Further using the O-ring as the elastic member, the tone wheel in which the circular magnetic body does not drop off the metal reinforcing ring without depending on an adhesive can be produced by the synergetic effect of the tightening effect of the O-ring to the circular magnetic body and the restraint force of the bent portion.

According to the production method of a tone wheel of the fourth aspect of the present invention, the elastic member is attached to the metal reinforcing ring in advance. Therefore, the edge of the metal reinforcing ring is bent after the circular magnetic body is disposed at a position opposite to the magnetic sensor and it does not require to consider the position where the elastic member is disposed, thereby facilitating the bending procedure and contributing to improve the productivity of the tone wheel.

According to the production method of a tone wheel of the fifth aspect of the present invention, even if the elastic member is disposed at the entire face where the outward brim portion of the metal reinforcing ring faces the magnetic sensor, the tone wheel can be produced according to the production method mentioned above. Further, the elastic member is arranged on the entire face of the metal reinforcing ring which confronts the magnetic sensor, so that the elastic member becomes a cushion material to prevent damage (breakage and deformation) of the circular magnetic body.

According to the production method of a tone wheel of the sixth aspect of the present invention, when the projecting portion is provided at one end or both ends of the elastic member, the tone wheel can be produced according to the production method mentioned above. Further, when the elastic material is provided with the projecting portion so as to embrace the both ends of the circular magnetic body, the embracing force to the circular magnetic body is increased and the tone wheel in which the metal reinforcing ring and the circular magnetic body are firmly fixed and integrated by the synergetic effect of the bending force (restraint force) by the bent portion.

According to the production method of a tone wheel of the seventh aspect of the present invention, the elastic member disposing portion is formed. Therefore, the elastic member can be easily disposed and positioned and it can be appropriately fixed to the circular magnetic body. In addition, the circular magnetic body and the elastic member are fixed to each other, so that they are not come off when being assembled into the metal reinforcing ring as the composite member.

According to the production method of a tone wheel of the eighth aspect of the present invention, the bent portion is formed with an acute angle, so that the embracing force of the circular magnetic body and the elastic member can be stabled. Therefore, the restraint force by the metal reinforcing ring can be further increased and they are more firmly fixed and integrated. For example when the tone wheel produced by this production method is fixed to the bearing unit member, drop-off of the circular magnetic body (drop-out into the axial direction and go-around in circles) is hardly happened.

According to the production method of a tone wheel of the ninth aspect of the present invention, when the bent portion is provided all around the peripheral edge of the metal reinforcing ring, the entire periphery can be uniformly restrained, thereby increasing the restraint force by the metal reinforcing ring and enabling to firmly fix and integrate them.

When a plurality of bent portions are provided in a circumferential direction, the bending process is easily done and its time can be reduced.

According to the production method of a tone wheel of the tenth aspect of the present invention, an elastic member is provided only at a required position of the bent portion.

### BRIEF DESCRIPTION OF DRAWINGS

FIG. 1 is a vertical sectional view showing one embodiment of a bearing structure assembled with a tone wheel produced by the production method of the first embodiment of the present invention.

FIG. 2 is an enlarged view of the area “X” in FIG. 1.

FIG. 3a through FIG. 3d show a production procedure of the tone wheel in FIG. 2.

FIG. 4a and FIG. 4b are sectional views showing a production procedure other than that shown in FIG. 3

FIG. 5 is a plane view showing one example of the tone wheel obtained by the production method of the present invention.

FIG. 6 is a plane view showing other example of the tone wheel obtained by the production method of the present invention.

FIG. 7 is a sectional view showing a modified example of the above-mentioned embodiment.

FIG. 8 is a sectional view showing a modified example of the above-mentioned embodiment.

FIG. 9 is a sectional view showing a modified example of the above-mentioned embodiment.

FIG. 10 is a sectional view showing a modified example of the above-mentioned embodiment.

FIG. 11 is a sectional view showing a modified example of the above-mentioned embodiment.

FIG. 12 is a sectional view showing other modified example of the above-mentioned embodiment.

FIG. 13 is a vertical sectional view showing one example of a bearing structure assembled with a tone wheel produced by the second embodiment of the present invention and also shows an enlarged view of the area “X” in FIG. 1.

FIG. 14a and FIG. 14b are sectional views showing the production procedure of the tone wheel in FIG. 13.

FIG. 15a and FIG. 15b are sectional views showing the production procedure of the modified example of the above-mentioned embodiment.

FIG. 16a and FIG. 16b are sectional views showing the production procedure of the modified example of the above-mentioned embodiment.

FIG. 17a and FIG. 17b are sectional views showing the production procedure of the modified example of the above-mentioned embodiment.

FIG. 18a and FIG. 18b are sectional views showing the production procedure of the modified example of the above-mentioned embodiment.

FIG. 19 is a sectional view showing a modified example of the above-mentioned embodiment.

FIG. 20a and FIG. 20b are sectional views showing the production procedure of the modified example of the above-mentioned embodiment.

FIG. 21 is a sectional view showing a modified example of the above-mentioned embodiment.

### BEST MODE FOR CARRYING OUT THE INVENTION

The best mode of the present invention is explained referring to the drawings.

### Embodiment 1

The first preferred embodiment is explained referring to the drawings.

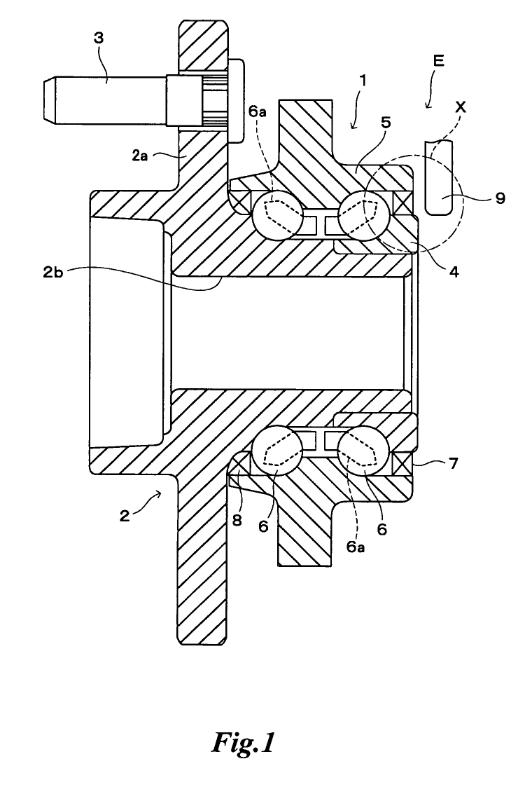

FIG. 1 shows one example of a supporting structure of the vehicle wheel with a rolling bearing unit 1. A tire wheel (not shown) is fixed to a hub flange 2a of a hub 2 constituting an inner wheel (rotary side member) with a bolt 3. The drive shaft (not shown) is spline fitted in a spline shaft hole 2b formed in the hub 2 and the rotary drive force of the drive shaft is transmitted to the tire wheel. The hub 2 constitutes an inner wheel together with an inner wheel member 4. An outer wheel (fixed side member) 5 is fixed to the vehicle suspension (not shown) of the vehicle body. Two rows of rolling elements (ball) 6 . . . are interposed between the outer wheel 5 and the inner wheel (hub 2 and inner wheel member 4) while being held with a retainer 6a. Outside of the axial direction of the orbit face of the two rows of rolling elements (ball) 6, seal rings 7, 8 are mounted to be press fitted between the outer wheel 5 and the inner wheel (hub 2 and inner wheel member 4) in order to prevent leakage of lubricant (such as grease) filled in a rolling portion of the rolling elements 6 . . . or to prevent muddy water and dirt from entering from the outside. A magnetic sensor 9 is provided for the outer wheel 5 or the vehicle body (stationary side member) so as to face the outer face of the seal ring 7 at the vehicle body side and constitutes a magnetic encoder E for detecting the rotation number of the tire wheel together with a tone wheel 10 mentioned later.

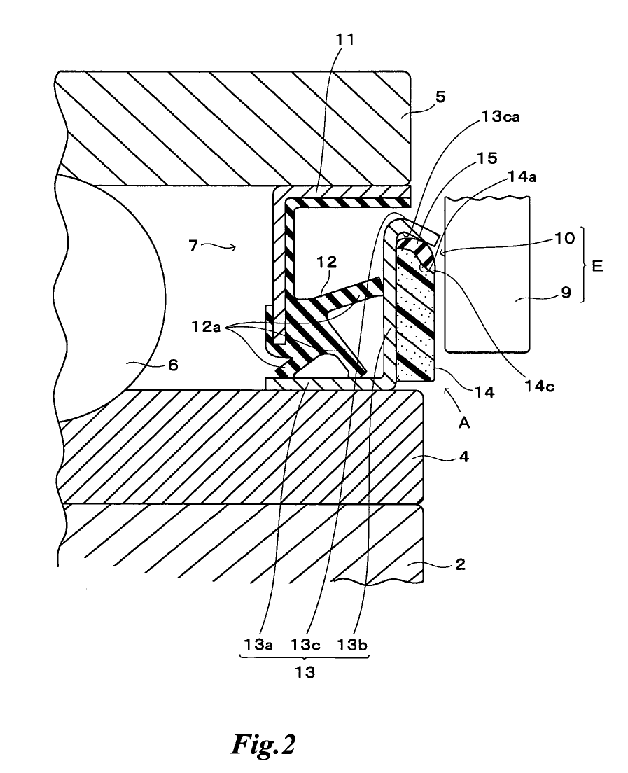

FIG. 2 shows an enlarged sectional view (enlarged view of the part “X” in FIG. 1) of the mounting portion of the seal ring 7 at the vehicle body side. The seal ring 7 comprises the tone wheel 10 to be integrally fitted into the outer circumference (external peripheral face) of the inner wheel member 4, a core member 11 to be press fitted into the inner circumference (inner peripheral face) of the outer wheel 5 and an elastic seal lip member 12, thereby constituting a pack seal type seal ring (referred to pack seal hereinafter). The elastic seal lip member 12 has a plurality of lips 12a . . . made of an elastic member such as rubber, of which tip ends elastically and slidably contact with the inner face (at rolling element 6 side) of the metal reinforcing ring (slinger) 13 constituting the tone wheel 10 and is fixed to the core member 11.

The present invention relates to a production method of the tone wheel 10 for use in a bearing unit of automobiles. The tone wheel 10 produced according to the present invention comprises a metal reinforcing ring (slinger) 13 having a cylindrical portion 13a to be fitted and fixed in the external peripheral face of the inner wheel member 4, an outward brim portion 13b integrally formed at an edge thereof and a bent portion 13c (bent part) which is formed by bending a portion extended at the outer periphery portion of the outward brim portion 13b in concentric with the cylindrical portion 13a in an opposite direction thereto. The tone wheel 10 also comprises a circular magnetic body 14 fixed and integrated to the outer face (at vehicle body side) of the outward brim portion 13b and the inner peripheral face of the bent portion 13c.

The production method of the tone wheel of the present invention is explained.

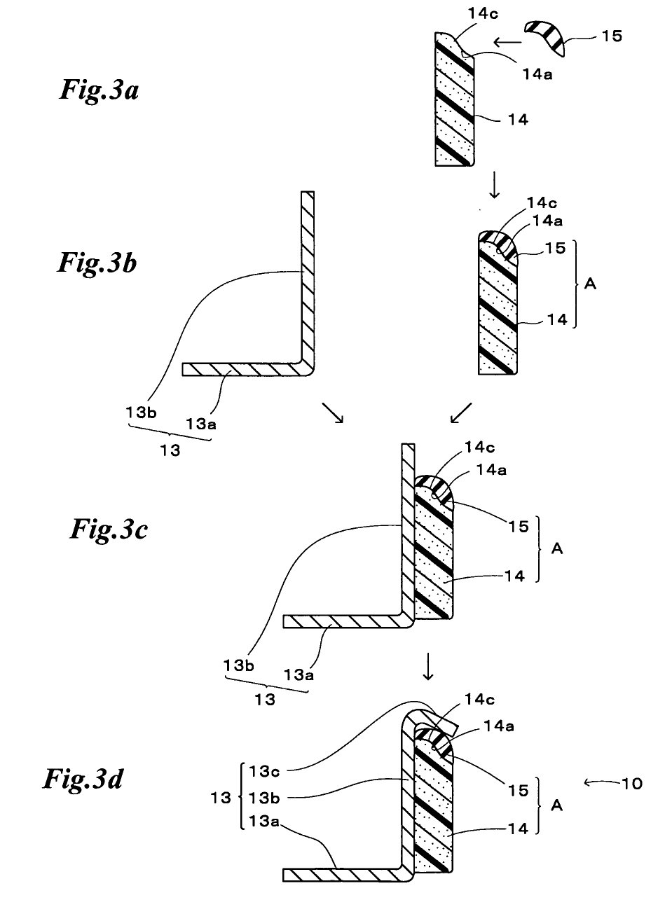

FIG. 3a-FIG. 3d are sectional views showing the production procedure of the tone wheel shown in FIG. 2.

At first, an elastic member 15 and the magnetic body 14 which are formed separately are combined to constitute a composite member (body) A (see FIG. 3a and FIG. 3b). An elastic member disposing portion 14c which is formed capable of combining the elastic member 15 and the magnetic body 14 is provided along the circumferential direction of an edge 14a (external peripheral face 14a) of the magnetic body 14.

The composite member A is disposed on the face, opposite to the magnetic sensor 9, of the outward brim portion 13b of the metal reinforcing ring 13 (FIG. 3c). Then the edge of the outward brim portion 13b is bent into the composite member A side and the edge of the composite member A is restrained by the bent portion 13c (bent part) to be fixed and integrated and the tone wheel 10 interposing the elastic member 15 between the metal reinforcing ring 13 and the magnetic body 14 is obtained (FIG. 3b).

The magnetic body 14 can be fixed and integrated to the metal reinforcing ring 13 without requiring an adhesive, however, it goes without saying that they may be fixed by means of a vulcanization adhesion or an adhesive, thereafter the bent portion 13c is formed and the elastic member 15 is fitted therebetween, thereby restraining them. The adhesive includes an epoxide-based adhesive, a phenolic adhesive, a coupling adhesive, sealant, an elastomeric adhesive, and the like.

The elastic member 15 which is fitted between the metal reinforcing ring 13 and the magnetic body 14, more specifically between the external peripheral face 14a of the magnetic body 14 and the internal peripheral face 13ca of the bent portion 13c, is used as a buffer material for preventing breakage and deformation of the magnetic body 14 and as a sealing material for preventing entering of water from the gap between the bent portion 13c and the magnetic body 14 into between the metal reinforcing ring 13 and the magnetic body 14. An elastic material may be rubber such as NBR, H-NBR, ACM, AEM, FKM and the like.

According to the production method of the tone wheel 10, a tone wheel in which the magnetic body 14 is firmly fixed and integrated to the metal reinforcing ring 13 by bending the edge of the metal reinforcing ring 13 can be produced. When processing such a bent portion, the elastic member 15 fitted between the metal reinforcing ring 13 and the magnetic body 14 is served as an appropriate buffer material and the bending force of the bent portion 13c is absorbed by the elastic member 15, therefore the bending force does not directly apply to the magnetic body 14. So, the bending process can be easily executed without having a fear of breaking or deforming the elastic body 14. As the result, the tone wheel 10 having a good yield ratio can be obtained.

Further according to thus produced tone wheel 10, the elastic member 15 is fitted between the bent portion 13c of the metal reinforcing ring 13 and the magnetic body 14, so that a sealing material is not required even when it is used in a severe environment like the detecting portion of vehicle rotation of automobiles where foreign material such as water, dirt, and dust are scattered, thereby preventing entering of water from the gap between the bent portion 13c and the magnetic body 14 into between the metal reinforcing ring 13 and the magnetic body 14. Therefore, by the effect as a buffer material and the effect as a sealing material of the elastic member 15 and by the bending process of the bent portion 13c, the tone wheel 10 in which the magnetic body 14 does not drop out of the metal reinforcing ring 13 and has a long durability can be obtained, thereby contributing to a highly reliable rotation detection. The tone wheel 10 produced by this production method has little fear of breakage and deformation of the magnetic body 14, so that it is not required to have concerns about the effect on the measurement accuracy of rotation detection by the bending procedure.

If a step-like elastic member disposing portion 14c is formed at the edge of the magnetic body 14 as shown in FIG. 2, the elastic member 15 is easily disposed and positioned when the elastic member 15 and the magnetic body 14 are combined and the elastic member 15 and the magnetic body 14 can be appropriately fitted. Further, when the composite member A is assembled into the metal reinforcing ring 13, the magnetic body 14 and the elastic member 15 are not drop off because they are fitted to each other.

When the tone wheel 10 and the magnetic sensor 9 constitute a magnetic encoder E, the magnetic body 14 is required to be a circular multipolar magnet being magnetized by providing a plurality of S poles and N poles alternately along the circumferential direction. According to the production method of the present invention, the magnetic body 14 after being magnetized may be assembled into the metal reinforcing ring 13 or it may be magnetized after being assembled into the metal reinforcing ring 13.

The magnetic body 14 is assembled into the metal reinforcing ring 13, then is magnetized, and constitutes the tone wheel 10, thereby constituting the magnetic encoder E having a little effect by the production difference of magnetic characteristic at the time of molding.

The magnetized magnetic body 14 may includes a rubber magnet, a plastic magnet, a sintered magnet and the like. More specifically, it may be a circular rubber magnet in which a magnetic rubber sheet containing a magnetic powder is magnetized by providing a plurality of N poles and S poles alternately along the circumferential direction, a circular plastic magnet in which a binder resin containing a magnetic powder is molded circular and is magnetized by providing a plurality of N poles and S poles alternately along the circumferential direction or a circular sintered magnet which is molded circular and is magnetized by providing a plurality of N poles and S poles alternately along the circumferential direction.

The above-mentioned magnetic powder includes a ferrite powder and a rare earth powder (NdFeB, SmFeN and the like), the rubber material for the magnetic rubber sheet is selected from NBR, H-NBR, ACM, AEM, FKM and the like, and a resin material (binder) for a plastic magnet includes a thermoplastic resin such as nylon 6, nylon 12, nylon 66, nylon 6T, nylon 9T, polyphenylene sulfide (PPS) and the like.

The external diameter of the plastic magnet 14 is designed to be substantially the same as or a little smaller than the inner diameter of the bent portion 13c of the metal reinforcing ring 13 and the metal reinforcing ring 13 and the magnetic body 14 are fixed and integrated by restraining at the edge (external peripheral face) 14a of the magnetic body 14 by the bent portion 13c which is formed by bending the edge of the metal reinforcing ring 13 into the magnetic body 14 side.

When the bent angle of the bent portion 13c is sharp like the bent portion 13c in the figure, the restraint force to the magnetic body 14 is increased and the composite member A and the metal reinforcing ring 13 can be firmly fixed and integrated.

The composite member A may be constituted by combining a separately molded one as mentioned above, however, it may be integrally molded by means of a molding die. Next, the case where the composite member A is integrally molded is explained.

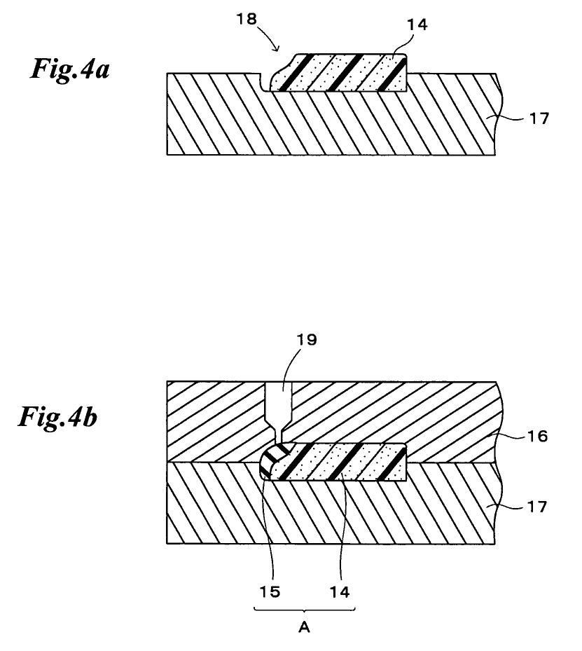

FIG. 4a and FIG. 4b show the production procedure, FIG. 4b shows after an unvulcanized rubber becomes hardened, however, it may not be limited to rubber and it may be a resin material.

The molding apparatus comprises an upper mold 16 and a lower mold 17, a cavity 18 is formed so as to obtain a desirably shaped elastic member 15, and an injection port 19 is provided for the upper mold 16 for charging an unvulcanized rubber in the cavity 18.

The magnetic body 14 which is molded in advance is placed at a fixed position in the cavity 18 of the lower mold 17 and thereafter the upper mold 16 is placed. An unvulcanized rubber is filled in the cavity 18 from the injection port 19 to be heated, vulcanized and hardened, thereby obtaining an integrally molded composite member A. In this case a vulcanizing adhesion using adhesive may be used.

The assembling method of thus obtained composite member A into the metal reinforcing ring 13 is the same as the above-mentioned embodiment, so its explanation is omitted here.

According to this method, the elastic member 15 is integrally molded with the magnetic body 14 at the time of molding with molds 16, 17, so that the magnetic body 14 and the elastic member 15 can be firmly integrated and the composite member A with the magnetic body 14 can be constituted by the molding of the elastic member 15, thereby eliminating the combining process of the magnetic body 14 and the elastic member 15, simplifying the production of the tone wheel 10, and more facilitating the production.

In the figure, an injection molding is used in the embodiment, however, it goes without saying that a compression molding is applicable.

The bent part, namely the bent portion 13c, of the metal reinforcing ring 13 may be formed all around the circumference of the metal reinforcing ring 13 and the elastic member 15 is also formed along the entire circumference corresponding to the magnetic body 14 and the metal reinforcing ring 13.

By such a structure, the entire circumference of the composite member A can be uniformly restrained, thereby increasing the restraint force of the metal reinforcing ring 13 and achieving a product in which the metal reinforcing ring 13 and the composite member A are firmly fixed and integrated each other.

Otherwise, the bent portion 13c and the elastic member 15 may be partially formed and constructed as mentioned below.

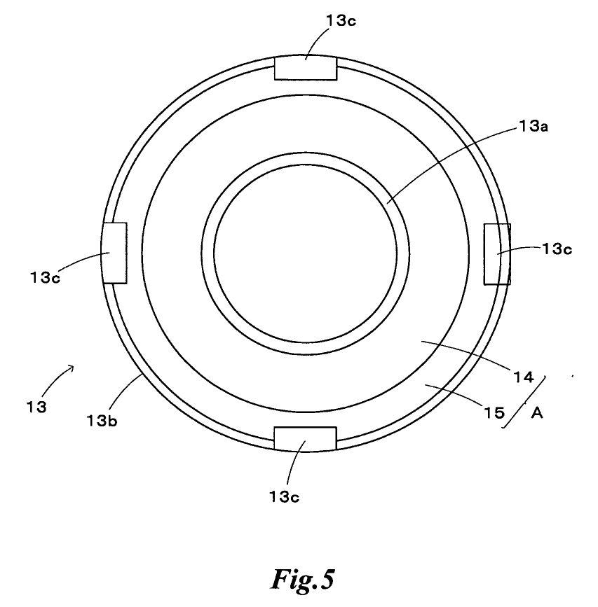

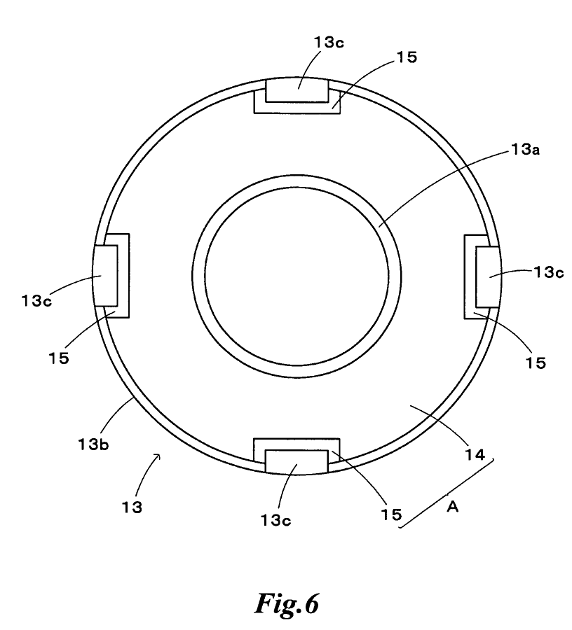

FIG. 5 and FIG. 6 show plane views of the tone wheel of the present invention.

In the example shown in FIG. 5, the elastic member 15 is formed at the entire circumference in accordance with the magnetic body 14 constructed as the composite member A and the bent portion 13c is partially formed at plural positions with a fixed space along the circumferential direction. The figure shows an example that the bent portion 13c is provided at four positions with substantially equal space, however, the present invention is not limited to it and arbitrary number of bent portions 13c may be provided at arbitral space in order that the composite member A does not drop off the metal reinforcing ring 13.

In this case, bending process is facilitated and the process time for bending can be reduced.

In the example of FIG. 6, the elastic member 15 is partially provided at a necessary position in accordance with the position where the bent portion 13c is formed along the circumferential direction of the magnetic body 14. The example shows that the bent portion 13c is formed at four positions with substantially equal space like the example in FIG. 5, however, the present invention is not limited to it and it is only required that the elastic member 15 is held and fitted in the position where the bent portion 13c is formed.

Although the tone wheel 10 of the present invention is designed to be one constituting member of the pack seal 7 in this embodiment, the magnetic encoder E may be constructed such that the tone wheel 10 is fitted into the rotary side member as a single member and the magnetic sensor 9 is arranged to confront the tone wheel 10. FIG. 1 and FIG. 2 show an example of a bearing unit 1 of the driving wheel in which the inner wheel is rotated. However, it goes without saying that the present invention can be applied to the bearing unit 1 of a driven wheel wherein the outer wheel is rotated. In this case, the tone wheel 10 is fitted and fixed into the outer wheel being a rotary side member.

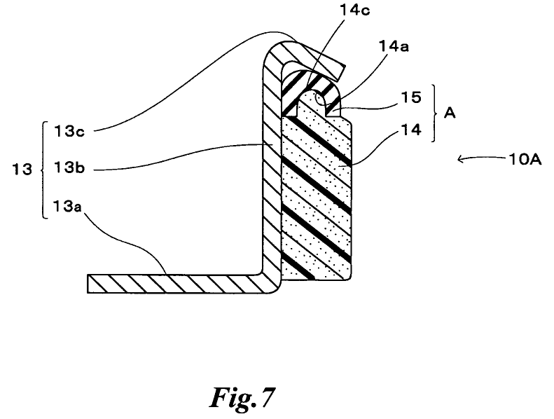

The tone wheels 10A-10C in FIG. 7-FIG. 9 show modified examples of the above-mentioned embodiment, respectively and the configurations of the elastic member 15 and the magnetic body 14 are different.

The tone wheel 10A shown in FIG. 7 is designed such that the elastic member 15 is held so as to cover the external peripheral face 14a of the magnetic body 14 which is restrained by the bent portion 13c and the elastic member disposing portion 14c of the external peripheral face 14a is formed convex along the circumferential direction and the elastic membrane 15 is formed in concave.

If the elastic member 15 is designed to cover the elastic member disposing portion 14c formed in convex on the external peripheral face 14, the embracing force to the magnetic body 14 is increased, thereby preventing dropout of the elastic member 15 before the composite member A is temporally attached to the metal reinforcing ring 13 and is restrained by the bent portion 13c. If the elastic member disposing portion 14c is formed on the external peripheral face 14a of the magnetic body 14, the elastic member 15 can be easily disposed and positioned and the elastic member 15 and the magnetic body 14 are combined and integrated as the composite member A, thereby facilitating the bending procedure and improving the productivity.

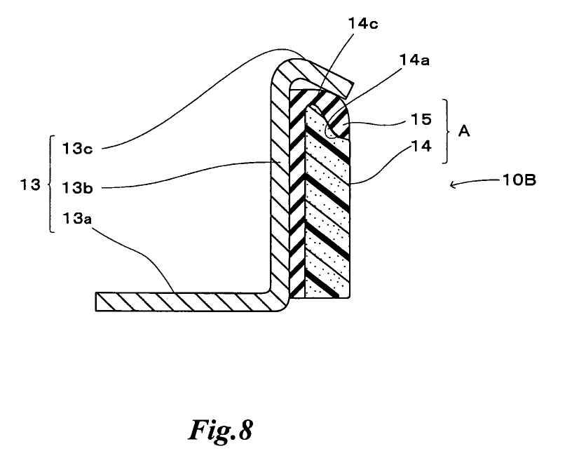

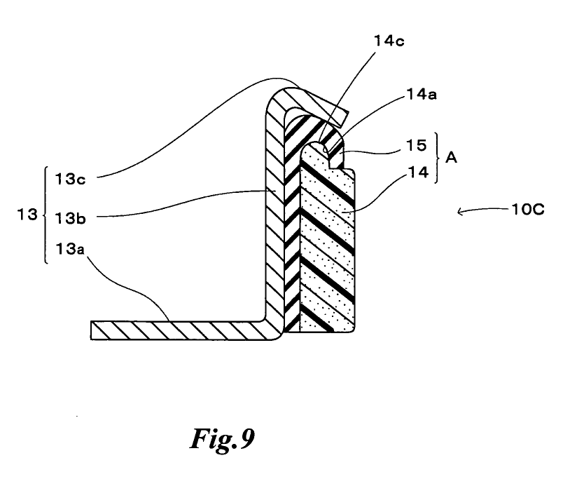

The tone wheels 10B, 10C in FIG. 8 and FIG. 9 are common to the embodiment in FIG. 7 in that the elastic member 15 is held so as to cover the external peripheral face 14a of the magnetic body 14 which is restrained by the bent portion 13c, however they are different in that the elastic member 15 is formed on the entire face of the metal reinforcing ring 13 opposite to the magnetic sensor 9 and the configuration of the elastic member disposing portion 14c is different.

According to the tone wheel 10B in FIG. 8, the elastic member disposing portion 14c at the external peripheral face 14a is formed like a gradual step in the circumferential direction and the elastic member 15 is formed in its corresponding shape.

According to the tone wheel 10C in FIG. 9, the elastic member disposing portion 14c on the external peripheral face 14a is formed in convex along the circumferential direction and the elastic member 15 is correspondingly formed in a convex manner.

In such a structure, by the synchronous effects of the embracing force of the elastic member 15 and the bending force of the bent portion 13c, the tone wheels 10B and 10C can be obtained in which the metal reinforcing ring 13 and the magnetic body 14 are more firmly fixed and integrated. Further, the elastic member 15 is arranged on the entire face of the metal reinforcing ring 13 opposite to the magnetic sensor 9, so that the elastic member 15 is served as a buffer material between the metal reinforcing ring 13 and the magnetic body 14 and the breakage and deformation of the magnetic body 14 can be prevented, thereby obtaining a highly durable tone wheel.

The elastic member 15 used here is preferably thin such that it does not become an obstacle for forming the bent portion 13c so as to alleviate the stress of the bent portion 13c.

The production method of the composite member A shown in FIG. 7-FIG. 9 includes a method wherein the elastic member 15 and the magnetic body 14, which are separately molded, are combined and a method wherein the composite member A is integrally molded by means of a molding die (see FIG. 4). Further, the bent portion 13c of the metal reinforcing ring 13 may be formed all around the circumference or may be partially formed with a fixed space. Still further, the elastic member 15 may be formed on the entire circumference or may be formed partially with a fixed space in accordance with the metal reinforcing ring 13.

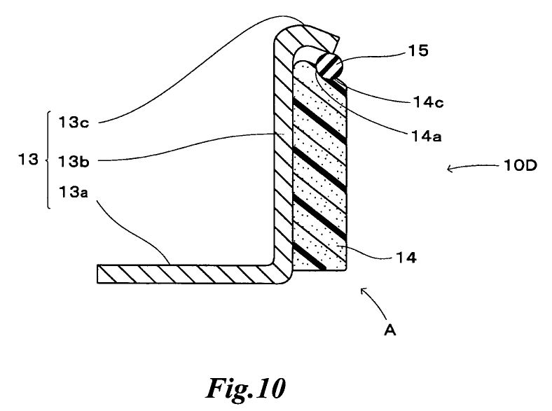

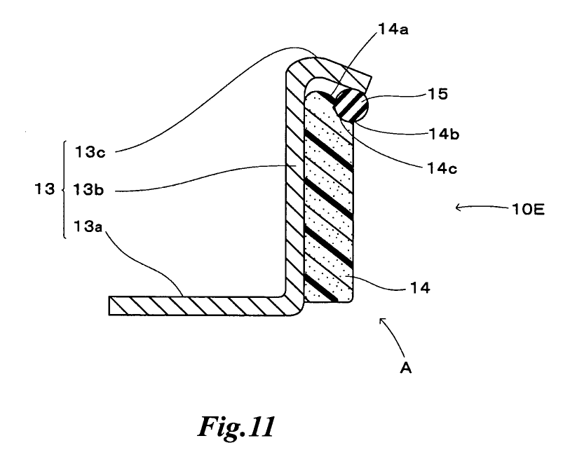

The tone wheels 10D, 10E in FIG. 10 and FIG. 11 show modified examples of the above-mentioned embodiment in which an O-ring is used as the elastic member 15. The example in FIG. 11 is different from that in FIG. 10 in that the disposed position of the elastic member 15 is at an angular portion 14b of the external peripheral face 14a of the magnetic body 14 at the magnetic sensor 9 side.

The elastic member disposing portion 14c of the tone wheel 10D in FIG. 10 is formed in concave so as to dispose the elastic member 15 constituting with an O-ring at the center of the outer peripheral face 14a.

The elastic member disposing portion 14c of the tone wheel 10E in FIG. 11 is provided in a form of cutout at the angular portion 14b being the magnetic sensor 9 side of the external peripheral portion 14a so as to dispose the elastic member 15 constituting with the O-ring.

If the O-ring is used as the elastic member 15, a commercially available O-ring can be used, thereby reducing the production cost. More specifically, when the commercially available O-ring which is selected depending on the size of the elastic member 14 is fitted in the elastic member disposing portion 14c, the composite member A can be constituted.

By the synergetic effect of the tightening effect into the magnetic body 14 by the O-ring and the restraint force of the bent portion 13c, the tone wheels 10D, 10E without causing drop-off of the magnetic body 14 can be obtained without depending on adhesive.

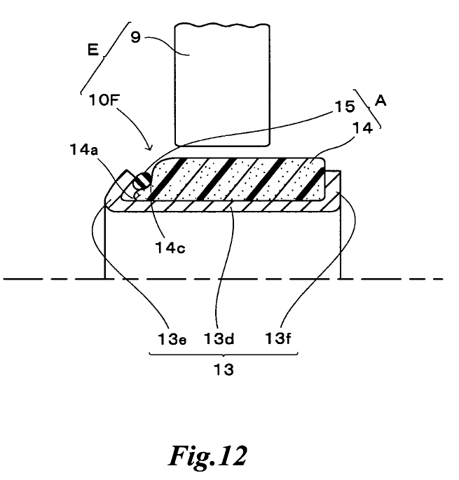

FIG. 12 shows further modified example.

The tone wheels 10, 10A-10E constitute an axial encoder, however, the production method of the present invention is applicable to the tone wheel 10F of a radial encoder type. The figure shows the O-ring is used as the elastic member 15, however, the shape of the elastic member 15 is not limited to it and it may be in such a shape for the tone wheels 10, 10A-10C.

The magnetic body 14 is cylindrical so as to be externally fitted to a cylindrical portion 13d of the metal reinforcing ring 13. The metal reinforcing ring 13 comprises the cylindrical portion 13d fitted and fixed into the external peripheral face of the rotary side member, a bent outward brim portion (bent portion) 13e integrally formed at one edge of the cylindrical portion 13d thereafter, and a bent outward brim portion 13f.

The composite member A is formed such that the elastic member 15 is disposed on the elastic member disposing portion 14c of the elastic body 14, the composite member A is externally fitted in the cylindrical portion 13d of the metal reinforcing ring 13, then the bent outward brim portion 13e is formed by bending the edge of the cylindrical portion 13d outwardly, thereby obtaining the tone wheel 10E in which the metal reinforcing ring 13 and the composite member A are firmly fixed and integrated. The tone wheel 10F is fitted and fixed into the external peripheral face of the rotary side member, thereby constituting the magnetic encoder E together with the magnetic sensor 9 which is adjacently confronted in the radial direction.

Such a tone wheel for a radial encoder may be fitted and fixed to the inner peripheral face of the rotary side member, however, in this case the cylindrical magnetic body 14 is internally fitted to the metal reinforcing ring 13 and the metal reinforcing ring 13 has an inward brim portion at both ends. The composite member A may be integrally formed by a molding die (see FIG. 4) when the O-ring is not used as the elastic member 15. Further, the bent outward brim portion 13e of the metal reinforcing ring 13 may be provided all around the metal reinforcing ring 13 or may be partially formed with a fixed space. If the O-ring is not used as the elastic member 15, the elastic member 15 may be designed to be formed all the circumference or to be partially formed in accordance with the bent position of the bent outward brim portion 13e.

The other construction in FIG. 7-FIG. 12 is the same as that shown in FIG. 2, the same reference numerals are allotted for the common members and their explanations are omitted here. The tone wheels 10A-10F produced according to the production method of the present invention may be a constitution member of the pack seal 7 as shown in FIG. 1 and FIG. 2, and otherwise they may be fitted in the rotary side member as a single member, or may be used for detecting the rotation of a driven wheel when the outer wheel is rotated, as mentioned above.

### Embodiment 2

The second preferred embodiment of the present invention is explained below referring to the drawings.

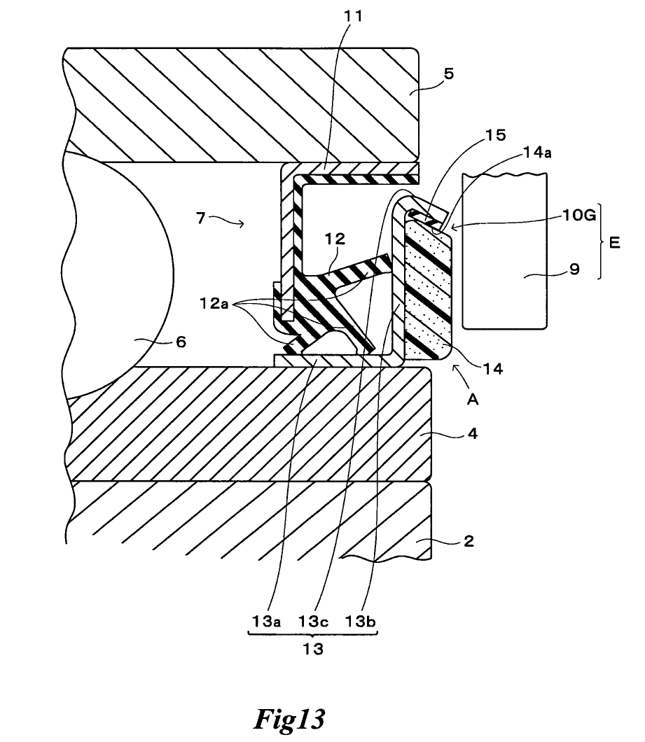

FIG. 13 shows a tone wheel of the second embodiment and shows an enlarged sectional view of the fitting portion of the seal ring at the vehicle body side (enlarged view corresponding to the area “X” in FIG. 1). The same reference numerals are allotted for the common members to the first embodiment and their explanations are omitted.

The seal ring 7 comprises a tone wheel 10 to be integrally fitted in the outer circumference (external peripheral face) of the inner wheel member 4, a core member 11 to be press fitted into the inner circumference (inner peripheral face) of the outer wheel 5 and an elastic seal lip member 12, thereby constituting a pack seal type seal ring (referred to pack seal hereinafter). The elastic seal lip member 12 has a plurality of lips 12a . . . made of an elastic member such as rubber, of which tip ends elastically and slidably contact with the inner face (at rolling element 6 side) of the metal reinforcing ring (slinger) 13 constituting the tone wheel 10 and is fixed to the core member 11. The tone wheel 10G in this embodiment is different from the above-mentioned embodiment in that the elastic member 15 is fixed and integrated to the metal reinforcing ring 13 in advance before forming the bent portion 13c.

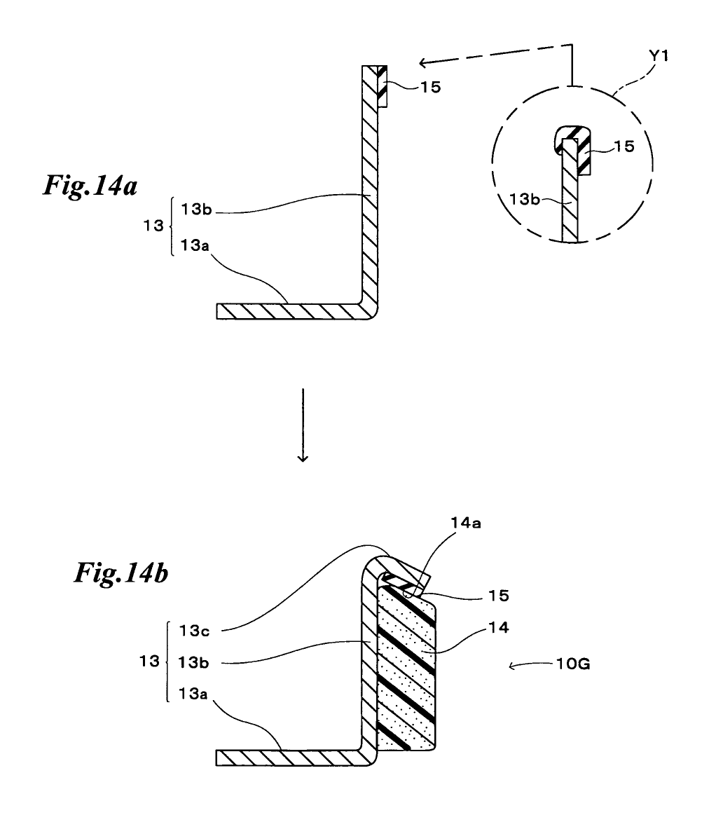

FIG. 14 shows the production procedure of the tone wheel 10G, FIG. 14a shows before the edge of the outward brim portion 13b of the metal reinforcing ring 13 is bent and FIG. 14b shows after the edge of the outward brim portion 13b is bent to form the bent portion 13c and the magnetic body 14 is restrained.

In the embodiment in FIG. 2, the magnetic body 14 and the elastic member 15 are combined to constitute the composite member A, the composite member A is placed at a predetermined position of the metal reinforcing ring 13, thereafter the edge of the outward brim portion 13b is bent and processed. However, according to the tone wheel 10G in this embodiment, the elastic member 15 is attached to the edge of the outward brim portion 13b of the metal reinforcing ring 13 by means of a vulcanizing adhesion or adhesive, and thereafter the magnetic body 14 is disposed on the face opposite to the magnetic sensor 9 of the metal reinforcing ring 13, the edge of the outward brim portion 13b is bent to form the bent portion 13c, and the edge of the magnetic body 14 is restrained by the bent portion 13c, thereby fixing and integrating them. Here the elastic member 15 is attached to the metal reinforcing ring 13 by means of a vulcanizing adhesion or adhesive.

Accordingly, the elastic member 15 is attached to the metal reinforcing ring 13 in advance, and the edge of the outward brim portion 13b is bent after the magnetic body 14 is positioned so as to face the magnetic sensor 9 so that it is not necessary to consider the position to which the elastic member 15 is positioned, thereby facilitating the bending process and contributing to improve the productivity of the tone wheel 10G. Further the elastic member 15 is held between the magnetic body 14 and the metal reinforcing ring 13, so that water is prevented from entering into the gap therebetween and the magnetic body 14 is prevented from being deteriorated or being peeled off the metal reinforcing ring 13.

The elastic member 15 is not limited to the one shown in the figure and may be formed so as to go around the inner side where the elastic seal lip member 12 slidably contacts from the outer face (at vehicle body side) of the outward brim portion 13b as shown in the enlarged view Y1 with a dotted line in FIG. 14a.

In this case, the metal reinforcing ring 13 and the elastic member 15 can be more firmly integrated in addition to the above-mentioned effects.

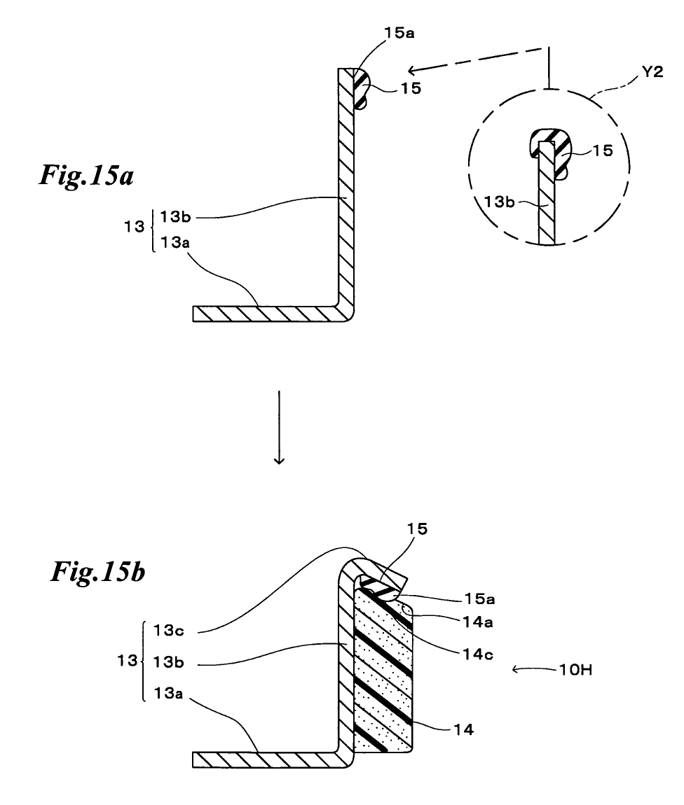

The tone wheel 10H shown in FIG. 15 is a modified example of the above-mentioned embodiment. FIG. 15 shows the production procedure of the tone wheel 10G, FIG. 15a shows before the edge of the outward brim portion 13b of the metal reinforcing ring 13 is bent and FIG. 15b shows after the edge of the outward brim portion 13b is bent to form the bent portion 13c and the magnetic body 14 is restrained.

The configuration of the elastic member 15 in this example is different from that of FIG. 14 and a projecting portion 15a having a bead-like section is provided for the elastic member 15 and the elastic member disposing portion 14c is formed on the external peripheral face 14a of the magnetic body 14 conforming the shape of the projecting portion 15a of the elastic member 15.

In this case, the elastic member 15 is rightly attached to a position corresponding to the bent portion 13c of the metal reinforcing ring 13 in advance and the elastic member disposing portion 14c is formed on the external peripheral face 14a of the magnetic body 14, so that it only requires to form the bent portion 13c in such a manner that the elastic member 15 is fitted to the elastic member disposing portion 14c. In addition, the elastic member disposing portion 14c is formed, so that the elastic member 15 and the magnetic body 14 can be fixed and integrated and can be sealed without requiring a sealing material in the gap therebetween. Further, the elastic member 15 is served as a cushion material to prevent breakage and deformation of the magnetic body 14, thereby obtaining a highly durable tone wheel.

The elastic member 15 is not limited to the one shown in the figure and may be formed so as to go around the inner side where the elastic seal lip member 12 slidably contacts from the outer face (at vehicle body side) of the outward brim portion 13b as shown in the enlarged view Y2 with a dotted line in FIG. 15a.

In this case, the metal reinforcing ring 13 and the elastic member 15 can be more firmly integrated in addition to the above-mentioned effects.

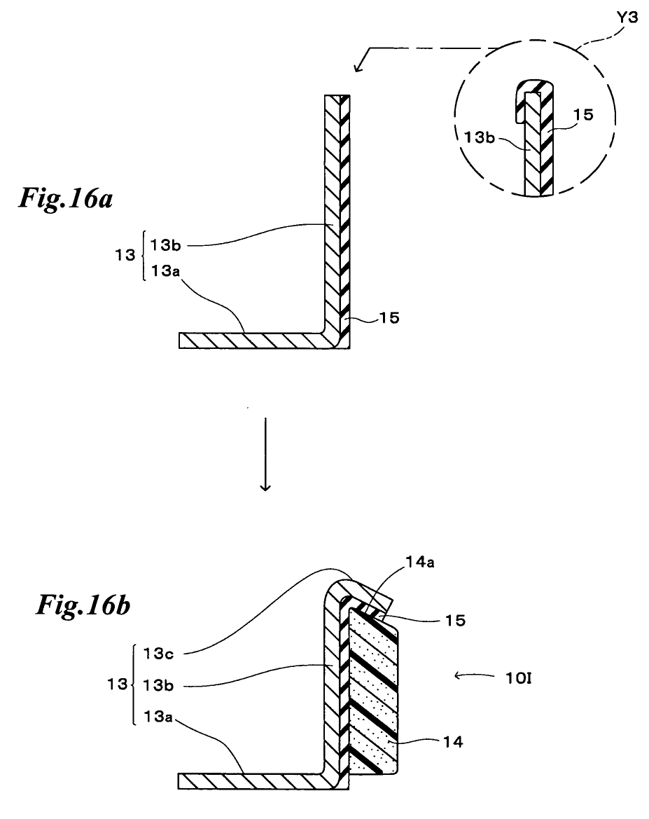

The tone wheels 10I-10N shown in FIG. 16-FIG. 20 respectively are further modified examples of the above-mentioned embodiment. FIG. 16a shows before the edge of the outward brim portion 13b of the metal reinforcing ring 13 is bent and FIG. 16b shows after the edge of the outward brim portion 13b is bent to form the bent portion 13c and the magnetic body 14 is restrained.

According to the tone wheel 10I, the elastic member 15 is attached and integrated in advance to the entire face opposite to the magnetic sensor 9 of the outward brim portion 13b of the metal reinforcing ring 13, the magnetic body 14 is placed at a position opposite to the magnetic sensor 9, and thereafter, the outward brim portion 13b is bent into the magnetic body 14 side to form the bent portion 13c, and the magnetic body 14 is restrained by the bent portion 13c, thereby fixing and integrating the metal reinforcing ring 13 with the magnetic body 14.

In this case, when the outward brim portion 13b of the metal reinforcing ring 13 is bent into the magnetic body 14 side, the bending procedure is easy because the elastic member 15 is attached to the metal reinforcing ring 13 in advance and the elastic member 15 is attached to the metal reinforcing ring 13, specifically it is attached to the entire face opposite to the magnetic sensor 9 of the metal reinforcing ring 13. Further, the gap between the metal reinforcing ring 13 and the elastic member 15 and the gap between the elastic member 15 and the magnetic body 14 can be sealed without using a sealing material. In addition, the breakage and deformation of the magnetic body 14 are prevented while the elastic member 15 serves as a cushioning material, thereby obtaining a highly durable tone wheel 10I.

The elastic member 15 is not limited to the one shown in the figure and may be formed so as to go around the inner side where the elastic seal lip member 12 slidably contacts from the outer face (at vehicle body side) of the outward brim portion 13b as shown in the enlarged view Y3 with a dotted line in FIG. 16a.

In this case, the metal reinforcing ring 13 and the elastic member 15 can be more firmly integrated in addition to the above-mentioned effects.

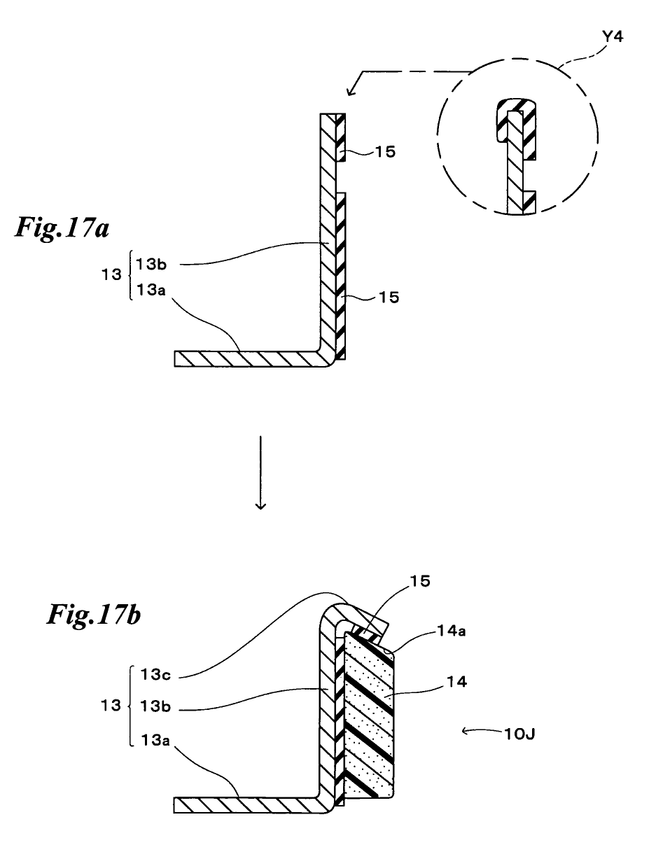

In this embodiment, the example shown in FIG. 17 can be applied.

FIG. 17a shows before the edge of the outward brim portion 13b of the metal reinforcing ring 13 is bent and FIG. 17b shows after the edge of the outward brim portion 13b is bent to form the bent portion 13c and the magnetic body 14 is restrained.

The tone wheel 10J is designed such that the elastic member 15 is not provided where the outward brim portion 13b is bent. Namely, the elastic member 15 is held only between the bent portion 13c and the external peripheral face 14a corresponding to the circumferential edge of the magnetic body 14 and between the metal reinforcing ring 13 facing the magnetic sensor 9 and the magnetic body 4.

In this case, the elastic member 15, which usually exists at the bent portion, does not become an obstacle when the outward brim portion 13b is bent into the magnetic body 14 side, thereby further facilitating the bending procedure and improving the productivity. Further, the bent portion 13c can be easily formed more sharply, so that the restraint force can be improved by the bent portion 13c, thereby obtaining the tone wheel 10J in which the metal reinforcing ring 13 and the magnetic body 14 are more firmly fixed and integrated.

The elastic member 15 is not limited to the one shown in the figure and may be formed so as to go around the inner side where the elastic seal lip member 12 slidably contacts from the outer face (at vehicle body side) of the outward brim portion 13b as shown in the enlarged view Y4 with a dotted line in FIG. 17a.

In this case, the metal reinforcing ring 13 and the elastic member 15 can be more firmly integrated in addition to the above-mentioned effects.

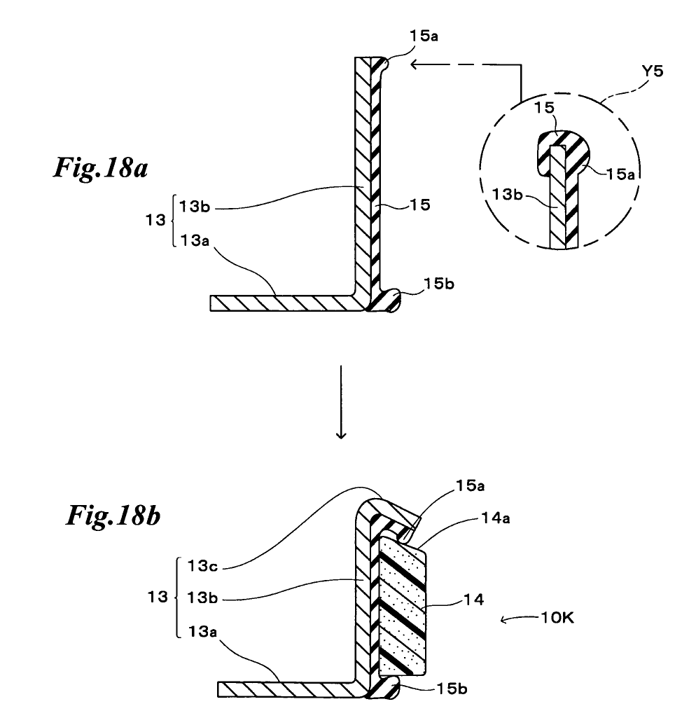

The tone wheels 10K, 10L, 10N shown in FIG. 18-FIG. 20 respectively are designed such that the elastic member 15 is fixed and integrated to the metal reinforcing ring 13 in advance before the bending process like the example in FIG. 14 and the configuration of the elastic member 15 is different from that in FIG. 14.

In these examples, projecting portions 15a, 15b are provided at both ends of the elastic member 15.

The elastic member 15 is designed to have the projecting portions 15a, 15b so as to embrace the both ends of the magnetic body 14, water can be prevented from entering between the magnetic body 14 and the elastic member 15 and the magnetic body 14 is prevented from being deteriorated. Further, the both ends of the magnetic body 14 are embraced with the projecting portions 15a, 15b, thereby preventing the magnetic body 14 from dropping off the metal reinforcing ring 13 to obtain a highly durable tone wheels 10K, 10L, 10N. Further, the elastic member 15 works as a buffer material to avoid damage (breakage and deformation) of the magnetic body 14 and has a strong embracing force to the magnetic body 14, thereby obtaining the tone wheels 10K, 10L, 10N in which the metal reinforcing ring 13 and the circular magnetic body 14 can be firmly fixed and integrated by the synergetic effect with the bending force (restraint force) of the bent portion.

In this case, the elastic member 15 used here is preferably thin such that it does not become an obstacle for forming the bent portion 13c so as to alleviate the stress of the bent portion 13c.

The projecting portions 15a, 15b are not limited to be formed at both ends shown in the figure, however, it may be formed either one end and the shape thereof is not limited to the one in the figure.

The tone wheel 10K in FIG. 18 is an example in which the elastic member disposing portion 14c is not provided at the external peripheral face 14a and the inner wheel 4 side of the magnetic body 14.

In this case, the convex projecting portion 15a is compressed and deformed into the external peripheral face 14a of the magnetic body 14 by the restraint force of the bent portion 13c to depress the magnetic body 14, and further is embraced by the elastic reaction force of the projecting portion 15b provided at the inner wheel 4 side of the magnetic body 14, thereby increasing the restraint force into the magnetic body 14 and obtaining the firmly integrated tone wheel 10K.

The elastic member 15 is not limited to the one shown in the figure and may be formed so as to go around the inner side where the elastic seal lip member 12 slidably contacts from the outer face (at vehicle body side) of the outward brim portion 13b as shown in the enlarged view Y5 with a dotted line in FIG. 18a.

In this case, the metal reinforcing ring 13 and the elastic member 15 can be more firmly integrated in addition to the above-mentioned effects.

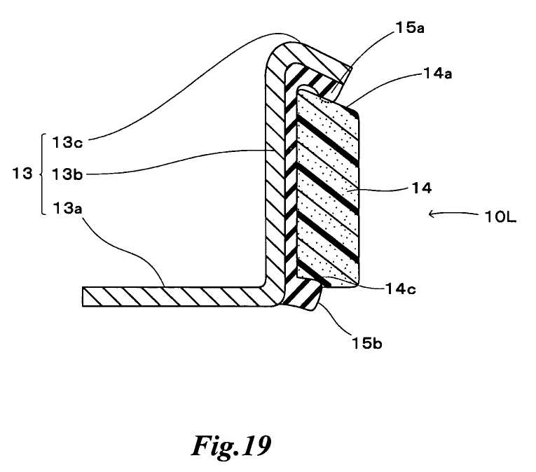

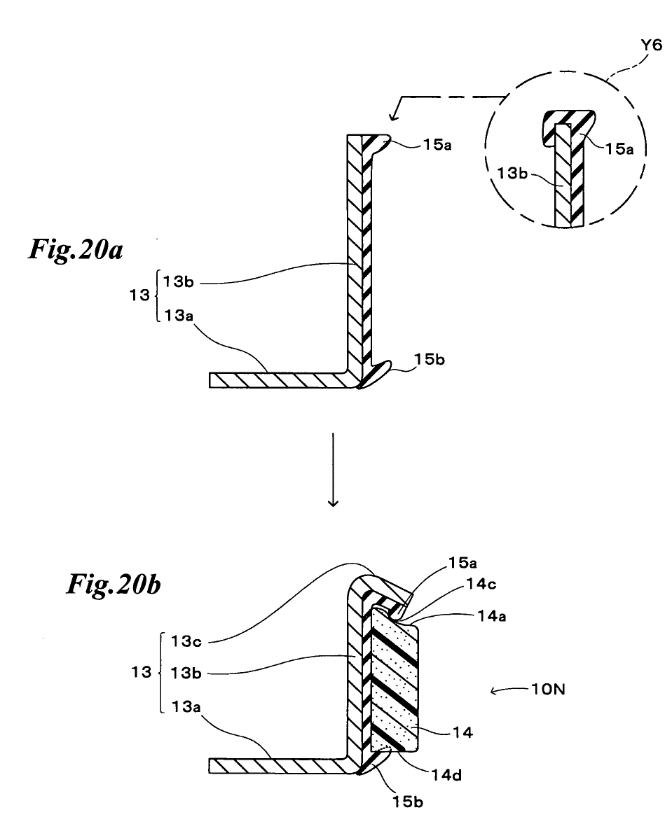

The tone wheels 10L, 10N shown in FIG. 19 and FIG. 20 respectively are different from that shown in FIG. 18 in that the elastic member disposing portion 14c is formed at the position with which the projecting portions 15a, 15b come into contact.

In FIG. 19, the external peripheral face 14a of the magnetic body 14 is a plane face and the elastic member displacing portion 14c is provided where the projecting portion 15b of the inner wheel 4 side comes contact with.

In this case, the convex projecting portion 15a is compressed and deformed into the external peripheral face 14a of the magnetic body 14 by the restraint force of the bent portion 13c to depress the magnetic body 14, and further the inner wheel 4 side of the magnetic body 14 is embraced by the projecting portion 15b fitted in the elastic member displacing portion 14c, thereby increasing the restraint force into the magnetic body 14 and obtaining the firmly integrated tone wheel 10L.

FIG. 20 shows the example in which the elastic member disposing portion 14c on the magnetic body 14 is formed on the external peripheral face 14a of the magnetic body 14 which is restrained by the bent portion 13c. In this embodiment, the projecting portion 15b at the inner wheel 4 side is formed like a lip and is elastically deformed to embrace the magnetic body 14.

The elastic member disposing portion 14c of the tone wheel 10N in FIG. 20 is formed corresponding to the shape of the projecting portion 15a formed in convex at the outer wheel 5 side.

In this embodiment, the elastic member 15 is fitted to the elastic member disposing portion 14c, the magnetic body 14 is restrained by the bent portion 13c via the elastic member 15, and the inner wheel 4 side of the magnetic body 14 is embraced by the elastic reaction force of the lip-like projecting portion 15b, so that the restraint force into the magnetic body 14 is further increased and a more firmly integrated tone wheel 10N can be obtained. The lip-like projecting portion 15b can prevent entering of water into the gap between the magnetic body 14 and the elastic member 15 and can avoid deterioration of the magnetic body 14 and peeling off of the magnetic body 14 from the metal reinforcing ring 13.

The elastic member 15 is not limited to the one shown in the figure and may be formed so as to go around the inner side where the elastic seal lip member 12 slidably contacts from the outer face (at vehicle body side) of the outward brim portion 13b as shown in the enlarged view Y6 with a dotted line in FIG. 20a. Although not showing in FIG. 19, the elastic member 15 may be provided similar to other examples.

In this case, the metal reinforcing ring 13 and the elastic member 15 can be more firmly integrated in addition to the above-mentioned effects.

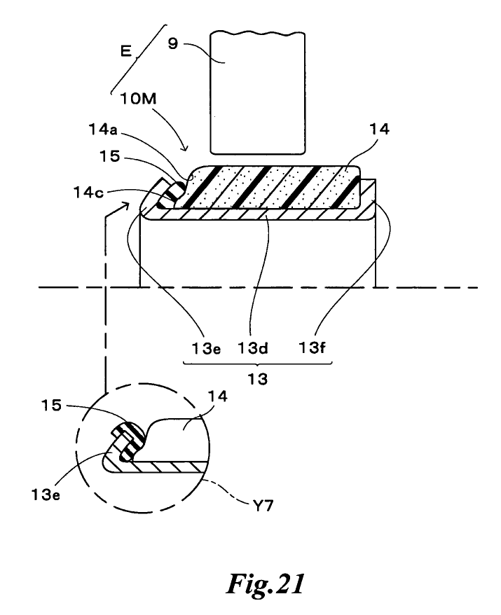

FIG. 21 shows a further modified example.

The tone wheels 10G-10N in the above-mentioned second embodiment constitute an axial encoder, however, the production method of the present invention is applicable to the tone wheel 10M of a radial encoder type. The figure shows the elastic member disposing portion 14c is formed on the magnetic body 14, however, the configurations of the elastic member 15 and the magnetic body 14 are not limited to them and they may be in a shape for the tone wheels 10G-10N. The elastic member 15 may be formed so as to go around into the outer face side from the inner side of the bent outward brim portion 13e (magnetic sensor 9 side) mentioned later as shown in the enlarged view Y7 with a dotted line in FIG. 21.

The magnetic body 14 is cylindrical so as to be externally fitted to a cylindrical portion 13d of the metal reinforcing ring 13. The metal reinforcing ring 13 comprises the cylindrical portion 13d fitted and fixed to the external peripheral face of the rotary side member, the bent outward brim portion (bent portion) 13e integrally formed at one edge of the cylindrical portion 13d, and the bent outward brim portion 13f, as mentioned in the example in FIG. 12 according to the embodiment 1.

The elastic member 15 is attached to the edge of the cylindrical portion 13d of the metal reinforcing ring 13 in advance and the magnetic body 14 is externally fitted in the cylindrical portion 13d of the metal reinforcing ring 13, then the bent outward brim portion 13e is formed by bending the edge of the cylindrical portion 13d outwardly, thereby obtaining the tone wheel 10M in which the metal reinforcing ring 13 and the magnetic body 14 are firmly fixed and integrated by restraining the magnetic body 14 via the elastic member 15. The tone wheel 10M is fitted and fixed to the external peripheral face of the rotary side member, thereby constituting the magnetic encoder E together with the magnetic sensor 9 which is adjacently confronted in the radial direction.

The other construction in FIG. 13-FIG. 21 is the same as that shown in FIG. 2, the same reference numerals are allotted for the common members and their explanations are omitted here. The bent part (a bent portion 13e in FIG. 21) of the metal reinforcing ring 13 may be formed all around the circumference of the metal reinforcing ring 13 or may be partially formed with a fixed space. Further the elastic member 15 is also formed along the entire circumference or partially formed in accordance with the metal reinforcing ring 13, as shown in FIG. 2. The tone wheels 10G-10N may be a constitution member of the pack seal 7 as shown in FIG. 2, and otherwise they may be fitted in the rotary side member as a single member, or may be used for detecting the rotation of a driven wheel when the outer wheel is rotated, as mentioned above.

The configurations of the elastic member, the magnetic body, the metal reinforcing ring are not limited to those in the figures. And the application examples of the production method of a tone wheel of the present invention are not limited in the above-mentioned embodiments. As long as the tone wheel is attached to a rotary side member and constitutes a magnetic encoder together with a magnetic sensor provided for a stationary side member, it goes without saying that the production method of a tone wheel of the present invention can be applied to the tone wheel used for a bearing, a bearing unit or a rotary shaft (driving shaft) at a rotating part which requires to detect the rotation. The metal reinforcing ring 13 in the figure is constructed such that the cylindrical portion 13a is fitted and fixed in the external peripheral face of the inner wheel member 4 (rotary side member) and the outward brim portion 13b is formed at its edge. However, the present invention is not limited to such a structure and it goes without saying that the present invention can be applied to an embodiment in which a brim portion (not shown) is formed at an edge of the cylindrical portion 13a inwardly relative to the axial direction.

1. A production method for a tone wheel, including a rotation detection magnetic encoder in combination with a magnetic sensor fixed onto a stationary side member, comprising a metal reinforcing ring fitted into a rotary side member and a circular magnetic body molded from a magnetic powder fixed to the metal reinforcing,
the method comprises the steps of:
providing the circular magnetic body, the circular magnetic body being formed with an elastic member disposing portion on its circumferential surface;
fixing an elastic member to the elastic member disposing portion to make a composite member body, the elastic member having a corresponding shape to be incorporated into the elastic member disposing portion; and
bending the circumferential edge of the metal reinforcing ring to fix the composite member body to the reinforcing ring, thereby producing a tone wheel with the elastic member disposed between said metal reinforcing ring and the circular magnetic body.

2. The production method for a tone wheel as set forth in claim 1, wherein: the composite member body is made by placing the circular magnetic body formed with the elastic member disposing portion in a cavity of a forming die and then charging an unvulcanized elastic member in the cavity for molding.

3. The production method for a tone wheel as set forth in claim 1, wherein:
the elastic member is an O-ring.

4. A production method for a tone wheel, including a rotation detection magnetic encoder in combination with a magnetic sensor fixed onto a stationary side member, a metal reinforcing ring fitted into a rotary side member, and a circular magnetic body fixed to the metal reinforcing ring, the circular magnetic body being molded from a magnetic powder, the method comprises the steps of:
attaching an elastic member to a surface of the metal reinforcing ring facing the magnetic sensor;
disposing the circular magnetic body on the surface of the metal reinforcing ring facing the magnetic sensor; and
bending the circumferential edge of the reinforcing ring to fix the circular magnetic body to the reinforcing ring, thereby producing a tone wheel with the elastic member disposed between the metal reinforcing ring and said the circular magnetic body.

5. The production method for a tone wheel as set forth in claim 1, wherein:
the metal reinforce ring has a cylindrical portion to be fitted into the rotary side member and an outward brim portion extendedly formed at an edge of the cylindrical portion; and
the outward brim portion faces to the magnetic sensor, and the elastic member is disposed circumferentially around the end of the circular magnetic body.

6. The production method for a tone wheel as set forth in claim 5, wherein:
a projecting portion is further provided at one end or at both ends of the elastic member.

7. The production method for a tone wheel as set forth in claim 4, wherein:
the elastic member disposing portion is made as a portion formed with a step on which the elastic member is incorporated.

8. The production method for a tone wheel as set forth in claim 1, wherein:
the metal reinforcing ring is formed with a bent portion with a sharp angle, by which the composite member body or the circumferential end of the circular magnetic body is fixed to the metal reinforcing ring.

9. The production method for a tone wheel as set forth in claim 1, wherein:
the bent portion is provided all around the edge of said metal reinforcing ring or a plurality of the bent portions are partially provided at the circumferential edge of the metal reinforcing ring.

10. The production method for a tone wheel as set forth in claim 1, wherein:
the elastic member is partially incorporated into the circumferential edge of the circular magnetic body.

11. The production method for a tone wheel as set forth in claim 4, wherein:
the metal reinforce ring has a cylindrical portion to be fitted into the rotary side member and an outward brim portion extendedly formed at an edge of the cylindrical portion; and
the outward brim portion faces the magnetic sensor, and the elastic member is disposed circumferentially around the end of the circular magnetic body.

12. The production method for a tone wheel as set forth in claim 4, wherein:
the metal reinforcing ring is formed with a bent portion with a sharp angle, by which the composite member body or the circumferential end of the circular magnetic body is fixed to the metal reinforcing ring.

13. The production method for a tone wheel as set forth in claim 4, wherein:
the bent portion is provided all around the edge of said metal reinforcing ring or a plurality of the bent portions are partially provided at the circumferential edge of the metal reinforcing ring.

14. The production method for a tone wheel as set forth in claim 4, wherein:
the elastic member is partially incorporated into the circumferential edge of the circular magnetic body.
